(19) United States
(12) Patent Application Publication
(10) Pub. No.: US 2026/0127429 A1
(43) Pub. Date: May 7, 2026

(54) DEVICE, DATA STRUCTURE, AND COMPUTER-IMPLEMENTED METHOD FOR DETERMINING A METRIC FOR EVALUATING A QUALITY OF A GENERATIVE, IN PARTICULAR MULTI-MODAL, FOUNDATION MODEL, FOR EXAMPLE FOR OPTICAL INSPECTION, FOR IDENTIFICATION OF SOUNDS OR TECHNICAL PARTS, FOR NATURAL LANGUAGE PROCESSING, FOR PROGAM GENERATION, OR LABELING DATA

(71) Applicant: Robert Bosch GmbH, Stuttgart (DE)

(72) Inventors: Jesko Hecking-Harbusch, Leonberg (DE); Jochen Quante, Ludwigsburg (DE); Matthias Woehrle, Bietigheim-Bissingen (DE); Maximilian Schlund, Stuttgart (DE); Sebastian Ernesto Sierra Loaiza, Stuttgart (DE)

(21) Appl. No.: 19/369,959

(22) Filed: Oct. 27, 2025

(30) Foreign Application Priority Data
Nov. 4, 2024 (DE) 10 2024 210 573.2

(51) Int. Cl. G06N 3/08

(52) U.S. Cl. CPC G06N 3/08

(57) ABSTRACT

Device, data structure, and computer-implemented method for determining a metric for evaluating a quality of a generative, in particular multi-modal, foundation model, for optical inspection, for identification of sounds or technical parts, for natural language processing, for program generation, or for labeling data. A first answer to a first question is determined using the generative foundation model. A second answer to a second question is determined using the generative foundation model. A relation between the first answer and the second answer is specified. The metric is determined depending on the answers and the relation.

### FIELD

The present invention relates to a device, a data structure and a computer-implemented method for determining a metric for evaluating a quality of a generative, in particular multi-modal, foundation model, for example for optical inspection, for identification of sounds or technical parts, for natural language processing, for program generation, or for labeling data.

### BACKGROUND INFORMATION

Generative foundation models, such as generative large, in particular multi-modal, language models (LLMs), are able to answer questions on different topics, that is, in different domains. Examples of the domains include optical inspection, identification of sounds or technical parts, natural language processing, program generation, or data labeling.

### SUMMARY

According to an example embodiment of the present invention, a computer-implemented method for determining a metric for evaluating a quality of a generative, in particular multi-modal, foundation model, for example for optical inspection, for identification of sounds or technical parts, for natural language processing, for program generation, or for labeling data, provides that a first answer to a first question is determined using the generative foundation model, wherein a second answer to a second question is determined using the generative foundation model, wherein a relation between the first answer and the second answer is specified, wherein the metric is determined depending on the answers and the relation. The method provides a metric with which the foundation model can be automatically trained or tested.

For example, a confidence level that the first answer and the second answer satisfy the relation is determined as a metric.

The confidence level is determined, e.g., by satisfying various individual relations for each relation.

The confidence level is output, for example, to a user of the foundation model. As a result, the user is informed of a quality of the foundation model with regard to the relation.

The use of the foundation model is blocked, for example, for an application domain that comprises the first question and/or the second question, if it is determined that the confidence level falls below a threshold value. As a result, use of the foundation model in domains in which the foundation model is unreliable is avoided.

For example, a reward is determined as a metric if the first answer and the second answer satisfy the relation, wherein the foundation model is trained depending on the reward. The reward makes training possible, depending on the reward.

The foundation model comprises, for example, an artificial neural network with weights, wherein the weights are determined depending on the reward.

The relation can be defined differently, preferably as a metamorphic relation.

The first answer, for example, comprises a set of individual answers to the first question, wherein the second answer comprises a set of individual answers to the second question, wherein the relation is specified such that the first answer and the second answer are disjoint sets of individual answers, or that the first answer is a subset of the second answer.

For example, the first question asks for a first program for performing a task in a first domain, wherein the second question asks for a second program for performing the task in a second domain, wherein the first domain comprises the second domain, wherein the relation is specified such that the first program and the second program solve the task in the second domain with the same result.

According to an example embodiment of the present invention, in particular for optical inspection, a first digital image representing an object is provided, the first digital image is transformed by a transformation into a second digital image representing the object, the first question asks for a position of the object in the first digital image, the second question asks for a position of the object in the second digital image, wherein the relation is specified by how the first digital image is transformed into the second digital image.

According to an example embodiment of the present invention, in particular for a sound, a first audio sequence having the sound is provided and a second audio sequence having the sound is provided, the first question asks for a point in time at which the sound occurs in the first audio sequence, the second question asks for a point in time at which the sound occurs in the second audio sequence, wherein the relation of the points in time is specified.

According to an example embodiment of the present invention, in particular for checking programs for a computer that are automatically generated by the foundation model, the first question asks, for example, for a result of a concatenation of a first program with a second program for performing a task on an input, wherein the second question asks for a result of a third program for performing the task on the input, wherein the relation is specified such that the third program solves the task with the same result as the concatenation of the first program with the second program.

It can be provided that a third answer to a third question is determined, for which the relation is expected to be that the third answer comprises the first answer and the second answer, or that the third answer is identical to the union of the first answer and the second answer.

According to an example embodiment of the present invention, a device for determining a metric for evaluating a quality of a generative, in particular multi-modal, foundation model, for example for optical inspection, for identification of sounds or technical parts, for natural language processing, for program generation, or for labeling data, provides that the device comprises at least one processor and at least one memory, wherein the at least one memory comprises instructions that, when executed by the at least one processor, cause the method to run on the device.

It is possible to provide a computer program, wherein the computer program comprises instructions that are executable by a computer and that, when executed by the computer, cause the method of the present invention to run on the computer.

According to an example embodiment of the present invention, a data structure for determining a metric for evaluating a quality of a generative, in particular multi-modal, foundation model, for example for optical inspection, for identification of sounds or technical parts, for natural language processing, for program generation, or for labeling data, provides that the data structure comprises at least one data field for a generative foundation model, at least one data field for a first answer to a first question determined using the generative foundation model, at least one data field for a second answer to a second question determined using the generative foundation model, at least one data field for a relation between the first answer and the second answer, and at least one data field for the metric determined depending on the answers and the relation.

Further advantageous embodiments of the present invention can be found in the following description and the figures.

### BRIEF DESCRIPTION OF THE DRAWINGS

FIG. 1 is a schematic representation of a device 100 for determining a metric for evaluating a quality of a generative, in particular multi-modal, foundation model, according to an example embodiment of the present invention.

FIG. 2 is a flowchart with steps of a method for determining the metric for evaluating a quality of the generative, in particular multi-modal, foundation model, according to an example embodiment of the present invention.

FIG. 3 is a schematic representation of a data structure for determining the metric for evaluating a quality of the generative, in particular multi-modal, foundation model, according to an example embodiment of the present invention.

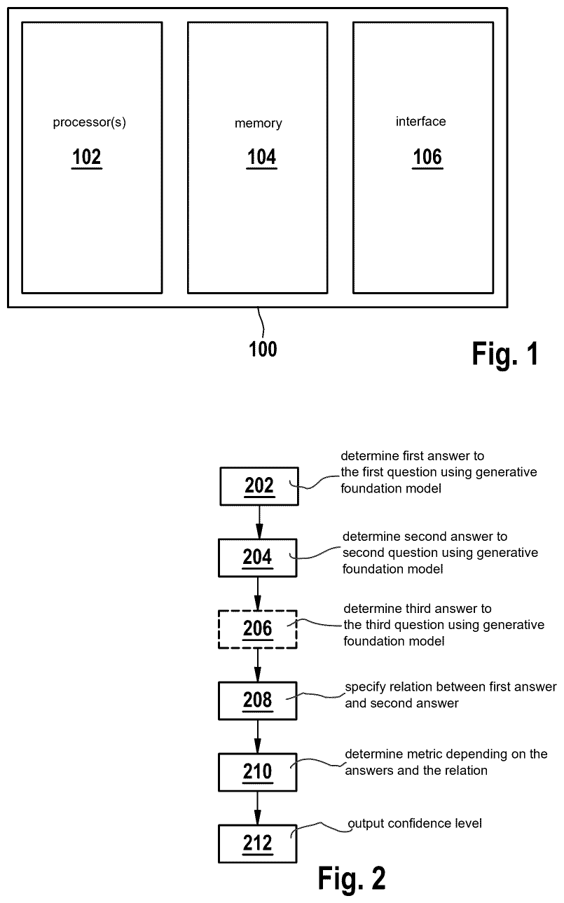

### DETAILED DESCRIPTION OF EXAMPLE EMBODIMENTS

The device 100 comprises at least one processor 102 and at least one memory 104. The at least one memory 104 stores instructions that are executable by the at least one processor 102 and that, when executed by the at least one processor 102, cause a method for determining the metric for evaluating a quality of a generative, in particular multi-modal, foundation model to run on the device 100.

It can be provided that the device 100 comprises an interface 106. The interface 106 comprises, e.g., a human-machine interface or a machine-machine interface.

The interface 106 is used, e.g., for inputting questions and outputting answers. The interface 106 can be designed to output indications relating to the answers.

An input comprises, e.g., text or a file. The file comprises, e.g., text, a digital image, an audio signal, and/or a program, i. e., e.g., computer program code. The multi-modal foundation model is, e.g., designed to process the input. An output comprises, e.g., text or a file. The file comprises, e.g., text, a digital image, an audio signal, and/or a program, i.e., e.g., computer program code. The multi-modal foundation model is, e.g., designed to output the output.

The input and the output are data, for example a natural language description and the program.

It can be provided that the at least one memory 104 comprises the foundation model.

The foundation model comprises, e.g., an artificial neural network with weights.

The generative foundation model is used, for example, for optical inspection, for identification of sounds or technical parts, for natural language processing, for program generation and/or for data labeling.

The generative foundation model is designed, for example, to process questions in the domain of optical inspection, the identification of sounds or technical parts, natural language processing, program generation and/or data labeling.

The generative multi-modal foundation model is designed to answer questions in at least two of the domains.

The foundation model is, e.g., a large language model (LLM).

In this example, the LLM is already trained to answer the questions. This means that the LLM is designed to output an answer to a question posed to the LLM. The answer to the question is determined using the generative foundation model.

The foundation model is trained, e.g., to take specified quality characteristics into account when generating its output. The training takes place, e.g., in an unsupervised manner.

An example of training an LLM in the program generation domain is for a programming task in “RLEF: Grounding Code LLMs in Execution Feedback with Reinforcement Learning” (arXiv:2410.02089v1).

The method for determining the metric for evaluating the quality of the generative, in particular multi-modal, foundation model is based on questions for which an expected relation between the answers is specified. The relation is, e.g., a metamorphic relation. The relation is described, e.g., in a formal language.

The method is described using the example of a first question and a second question and a relation between a first answer of the generative foundation model to the first question and a second answer of the generative foundation model to the second question. The example optionally describes the possibility of providing, instead of the relation between the first answer and the second answer, a third question and the relation between the first answer, the second answer and a third answer of the foundation model to the third question.

The method is not limited to three questions and three answers or the relation between two or three answers. There can be more than three questions, more than three answers, and more than one relation between the more than three answers. Various relations between the answers can be provided. Various relations can in each case be provided between some of the answers. At least one relation between the answers and at least one relation between some of the answers can be provided.

According to an example where it is known that the correct answer to the first question comprises a first set of individual answers, and the correct answer to the second question comprises a set of individual answers disjoint from the first set, the relation is specified, e.g., such that the first answer of the foundation model and the second answer of the foundation model are disjoint sets of individual answers.

According to an example where it is known that the correct answer to the first question comprises a first set of individual answers, and the correct answer to the second question comprises a set of individual answers encompassing the first set, the relation is specified, e.g., that the first answer of the foundation model is a subset of individual answers from the set of individual answers in the second answer of the foundation model.

In order to determine a program for performing a task in a first domain, it can be provided that a first question asks for a first program for performing the task in the first domain, and that a second question asks for a second program for performing the task in a second domain that comprises the first domain. For verification, it can be provided that the relation is specified such that the first program and the second program solve the task in the second domain with the same result.

It can be provided that the third question is formulated such that a correct answer to the third question comprises the first answer and the second answer. This means that for the third answer, the relation is specified such that the third answer comprises the first answer and the second answer.

It can be provided that the third question is formulated such that a correct answer to the third question is identical to the union of the first answer and the second answer. This means that for the third answer, the relation is specified such that the third answer is identical to the union of the first answer and the second answer.

For determining a first program, it can be provided that the first question asks for the result of concatenating the first program with a second program for performing a task on an input. The second question, e.g., asks for the result of a third program for performing the task on the input. For example, the relation is specified such that the third program solves the task with the same result as the concatenation of the first program with the second program.

For determining a position of an object in a first digital image, it can be provided that a first question asks for a position of the object in the first digital image and that a second question asks for a position of the object in a second digital image. The object is arranged, e.g., at a first position in the first image and at a second position in the second image. The second position is arranged a certain distance away from the first position in one direction. The first answer comprises a predicted first position of the object. The second answer comprises a predicted second position of the object. For the verification, e.g., the relation is specified such that the predicted second position in the second answer to the second question differs from the predicted first position in the first answer to the first question by the distance in the direction.

For a sound, e.g., in audio signals, it can be provided that a first audio sequence having a sound and a second audio sequence having the sound are provided. The first question asks, e.g., for a point in time at which the sound occurs in the first audio sequence, and the second question asks for a point in time at which the sound occurs in the second audio sequence. For the verification, e.g., the relation between the points in time is specified.

Determining the relation is carried out, for example, depending on the first question. Determining the relation can be carried out through an interaction between a computer program, e.g., a chatbot, designed for this purpose and a user. The computer program comprises, e.g., the generative foundation model.

The computer program is designed, e.g., to capture the first question from a user.

The computer program is designed, e.g., to ask the user, for example, about the relation in a follow-up query. The relation is, e.g., a metamorphic relation.

The computer program is designed, e.g., to determine the second question depending on the relation and the first question.

Optionally, the computer program is designed to determine the third question depending on the relation and the first question. The computer program is designed, e.g., to ask the generative foundation model the first question and the second question.

Optionally, the computer program is designed to ask the generative foundation model the third question.

The computer program is designed, e.g., to determine in a verification whether or not the answers to the questions posed satisfy the relation.

The computer program is, for example, designed to output a result of the verification to the user. The computer program is, for example, designed to output the result of the verification and the answers to the user. For example, the computer program is designed to output the answers to the user if the verification is successful, and otherwise not to output the answers to the user. The verification is successful, e.g., if the answers satisfy the relation.

For multiple relations, the verification is successful, e.g., if all relations are satisfied.

A first exemplary output of the computer program is “My answer is [. . . ] , but in this case I am not certain because my internal check has failed,” wherein [. . . ] represents at least one of the answers.

A second exemplary output of the computer program is “My answer is [. . . ] , and I am fairly certain because my internal check has worked, ” wherein [. . . ] represents at least one of the answers.

A first exemplary sequence of the computer program is described using the example of a question requesting a list of presidents of country X. In this example, four presidents of country X are known: President A, President B, President C, and President D. The last two presidents in this example are President A and President D. In the example, the first user question and the second user question are entered by a user into the computer program. The follow-up query is generated by the computer program, e.g., from a template for a follow-up query in response to a question requesting a list. The first question, the second question and the third question posed to the foundation model are generated by the computer program depending on the first question posed to the foundation model and the second question posed to the foundation model, e.g., from a template for questions requesting a list. The question requesting the list is recognized, e.g., by means of a classifier that assigns the question to the templates. In this example, the template for the question is associated with the relation that is expected from the answers to the questions posed to the foundation model. The follow-up queries and answers are output to the user by the computer program. The computer program queries the foundation model with the particular question and outputs the particular answer of the foundation model.

First user question: Name all the presidents of country X.

First question posed to the foundation model: Name all the presidents of country X.

First answer: President A, President B, President C, President D.

Follow-up query: I see you're looking for a list. Give me an example of a question that will help me find a shorter list.

Second user question: Name the last two presidents of country X.

Second question posed to the foundation model: Name the last two presidents of country X.

### Second Answer: President a, President D.

Third question posed to the foundation model: Name all presidents of country X, excluding the last two presidents of country X.

### Third Answer: President B, President C.

Relation: {second answer, third answer}==first answer. This means that the expected relation is that the union of the list of presidents from the second answer and the list of presidents from the third answer is equal to the list of presidents from the first answer.

A second exemplary sequence of the computer program is described using the example of a question requesting a program for checking whether a graph is a tree. In this example, a graph is a tree if the graph is connected and has no cycles.

In this example, the user questions are entered by a user into the computer program. The follow-up query is generated by the computer program, e.g., from a template for a follow-up query in response to a question requesting a program. The follow-up queries and answers are output to the user by the computer program. The computer program queries the foundation model with the particular question posed to the foundation model and outputs the particular answer of the foundation model. The question requesting the program is recognized, e.g., by means of a classifier that assigns the question to the template. In this example, the template is associated with the relation expected from the answers to the questions posed to the foundation model.

First user question: Write me a checker to determine if a graph is a tree.

First question posed to the foundation model: Write me a checker to determine if a graph is a tree.

Follow-up query: Give me a list of subtasks into which I can divide this task.

First answer: Program 1—checker to determine if a graph is a tree

Second user question: 1. Write a checker to determine if a graph is connected. 2. Write a check to determine if a graph has a cycle.

Second question posed to the foundation model: Write a checker to determine if a graph is connected.

Second answer: Program 2—checker to determine if a graph is connected

Third question posed to the foundation model: Write a checker to determine if a graph has a cycle

Third answer: Program 3—checker to determine if a graph has a cycle

In this example, the relation relates to the results that the programs deliver for a test graph:
Result 1: Application of program 1 to the test graph
Result 2: Application of program 2 to the test graph
Result 3: Application of program 3 to the test graph

In the example, result 1 is true if the graph is a tree, and false otherwise.

In the example, result 2 is true if the graph is connected, and false otherwise.

In the example, result 3 is true if the graph has no cycle, and false otherwise.

Relation: result 2 & result 3==result 1. This means the expected relation is that result 1 is true if result 2 and result 3 are both true, and result 1 is false otherwise.

In one example, an indication is output to the user along with the answers. The indication is determined differently, e.g., depending on whether or not the answers satisfy the expected relation.

An exemplary indication for answers that do not satisfy the relation:

“My result is: “Program 1.” In addition, here is the code for the sub-steps: “Program 2, program 3.”

Unfortunately, I am not sure, because I tested program 1 for you in a test using a test graph. The test revealed a difference between the result from program 1 and the results from the sub-steps. Therefore, be careful if you continue to use the code.”

The verification of whether the questions satisfy the expected relation is used to determine a metric for evaluating the quality of the generative, in particular multi-modal, foundation model.

The method determines the metric for evaluating the quality.

The method comprises a step 202.

In step 202, the first answer to the first question is determined using the generative foundation model.

The method comprises a step 204.

In step 204, the second answer to the second question is determined using the generative foundation model.

The method optionally comprises a step 206. Step 206 is carried out, e.g., if a relation between three answers needs to be checked.

In step 206, the third answer to the third question is determined using the generative foundation model.

The method comprises a step 208.

In step 208, the relation is specified.

For example, the relation between the first answer and the second answer is specified. Optionally, if the third question is used, the relation between the first answer, the second answer and the third answer is specified.

The method comprises a step 210.

In step 210, the metric is determined depending on the answers and the relation.

It can be provided that multiple alternative formulations of the questions are posed to the foundation model. The relation is checked individually in a particular verification, e.g., for the answers that the foundation model provides for multiple alternative formulations of the questions posed to the foundation model.

The metric is determined, for example, depending on the result of the particular verification.

For example, a confidence level that the first answer and the second answer satisfy the relation is determined as a metric.

Optionally, it can be provided that, if the third question is used, a confidence level that the first answer, the second answer and the third answer satisfy the relation is determined as a metric.

For example, a value greater than zero represents a confidence level and a value of zero represents no confidence level.

For example, if multiple verifications are performed, the values of the confidence level from the individual verifications are added or multiplied to form a total value, wherein an increasing total value represents an increasingly greater confidence level.

For example, a reward is determined as a metric if the first answer and the second answer satisfy the relation.

Optionally, it can be provided that, if the third question is used, a reward is determined as a metric if the first answer, the second answer and the third answer satisfy the relation.

For example, no reward is determined otherwise. For example, a value greater than zero represents the reward and a value of zero represents no reward.

For example, if multiple verifications are performed, the values of the reward from the individual verifications are added or multiplied to form a total value, wherein an increasing total value represents an increasingly greater reward.

The method comprises a step 212.

In step 212, it can be provided that the confidence level is output in particular to the user of the foundation model.

In step 212, it can be provided that the use of the foundation model is blocked for an application domain that comprises the first question and/or the second question, if it is determined that the confidence level falls below a threshold value.

In step 212, it can be provided that the foundation model is trained depending on the reward.

For example, the weights are determined depending on the reward.

Depending on the result of the verification, it can be provided to actuate a computer-controlled or computer-regulated machine, such as a robot system, a vehicle, a household appliance, a machine tool, a production machine, a personal assistance system or an access-control system, depending on the first answer, the second answer, and/or the third answer. For example, the actuation is carried out depending on the first answer, the second answer, and/or the third answer if it is determined that the verification has been successful. For example, otherwise no actuation takes place depending on the first answer, the second answer, and/or the third answer, in particular if it has been determined that the verification was not successful.

For example, in a robot system for gripping objects, the first digital image is an image that captures the object in the first position, wherein the second digital image is an image that captures the object in the second position. For example, the object is gripped or not gripped at the second position depending on whether the relation is satisfied that the position in the answer to the second question differs from the position in the answer to the first question by the distance in the direction.

For example, in a vehicle for autonomous driving, the first digital image is an image that captures the object in the first position, wherein the second digital image is an image that captures the object in the second position. For example, the vehicle driving over the object is avoided or not avoided depending on whether the relation is satisfied that the position in the answer to the second question differs from the position in the answer to the first question by the distance in the direction.

The distance and the direction are determined, e.g., depending on a specified expected trajectory of the object. The trajectory is estimated, e.g., depending on multiple captured images.

For optical inspection, for example, a first digital image representing an object is provided. The first digital image is transformed by a transformation into a second digital image. The second digital image represents the object. For example, the relation is specified by how the first digital image is transformed into the second digital image. This means that it is checked whether or not the transformation of the first image leads to an expected representation of the object in the second image.

The images are captured, e.g., using a camera, a radar sensor, a LiDAR sensor, an infrared camera, a motion sensor or an ultrasonic sensor.

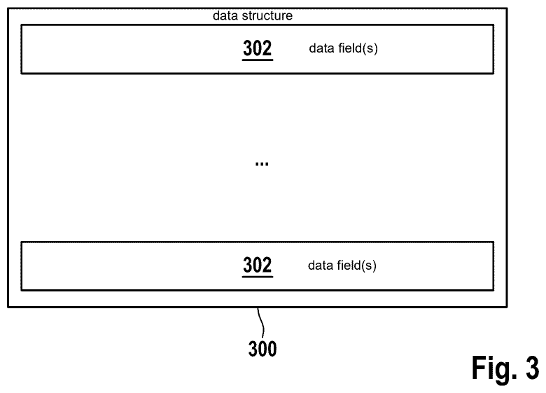

FIG. 3 schematically shows an exemplary data structure 300 for determining the metric.

The data structure 300 comprises at least one data field 302 for a generative foundation model, at least one data field 302 for a first answer to a first question, which is determined using the generative foundation model, at least one data field 302 for a second answer to a second question, which is determined using the generative foundation model, at least one data field 302 for a relation between the first answer and the second answer, and at least one data field 302 for the metric, which is determined depending on the answers and the relation.

1-15. (canceled)

16. A computer-implemented method for determining a metric for evaluating a quality of a generative, multi-modal, foundation model, the method comprising the following steps:
determining a first answer to a first question using the generative foundation model;
determining a second answer to a second question using the generative foundation model;
specifying a relation between the first answer and the second answer; and
determining the metric depending on the first and second answers and the relation.

17. The method according to claim 16, wherein the foundation model is for: (i) optical inspection, or (ii) identification of sounds or technical parts, or (iii) natural language processing, or (iv) program generation, or (v) labeling data.

18. The method according to claim 16, wherein a confidence level that the first answer and the second answer satisfy the relation is determined as the metric.

19. The method according to claim 18, wherein the confidence level is output to a user of the foundation model.

20. The method according to claim 18, wherein use of the foundation model is blocked for an application domain that includes the first question and/or the second question, when it is determined that the confidence level falls below a threshold value.

21. The method according to claim 16, wherein a reward is determined as the metric when the first answer and the second answer satisfy the relation, and the foundation model is trained depending on the reward.

22. The method according to claim 21, wherein the foundation model includes an artificial neural network with weights, wherein the weights are determined depending on the reward.

23. The method according to claim 16, wherein the first answer includes a set of individual answers to the first question, wherein the second answer includes a set of individual answers to the second question, wherein the relation is specified such that: (i) the first answer and the second answer are disjoint sets of individual answers, or (ii) the first answer is a subset of the second answer.

24. The method according to claim 16, wherein the first question asks for a first program for performing a task in a first domain, wherein the second question asks for a second program for performing the task in a second domain, wherein the first domain includes the second domain, wherein the relation is specified such that the first program and the second program solve the task in the second domain with the same result.

25. The method according to claim 16, wherein a first digital image representing an object is provided, the first digital image is transformed by a transformation into a second digital image representing the object, the first question asks for a position of the object in the first digital image, the second question asks for a position of the object in the second digital image, wherein the relation is specified by how the first digital image is transformed into the second digital image.

26. The method according to claim 16, wherein a first audio sequence having a sound is provided, a second audio sequence having the sound is provided, the first question asks for a point in time at which the sound occurs in the first audio sequence, wherein the second question asks for a point in time at which the sound occurs in the second audio sequence, wherein the relation of the points in time is specified.

27. The method according to claim 16, wherein the first question asks for a result of a concatenation of a first program with a second program for performing a task on an input, wherein the second question asks for a result of a third program for performing the task on the input, wherein the relation is specified such that the third program solves the task with the same result as the concatenation of the first program with the second program.

28. The method according to claim 16, wherein a third answer to a third question is determined, for which the relation is expected to be that: (i) the third answer includes the first answer and the second answer, or (ii) the third answer is identical to a union of the first answer and the second answer.

29. A device for determining a metric for evaluating a quality of a generative, multi-modal, foundation model, the device comprising:
at least one processor; and
at least one memory, wherein the at least one memory includes instructions that, when executed by the at least one processor, cause a method to run on the device, the method including the following steps:
determining a first answer to a first question using the generative foundation model,
determining a second answer to a second question using the generative foundation model,
specifying a relation between the first answer and the second answer, and
determining the metric depending on the first and second answers and the relation.

30. A non-transitory storage medium on which is stored a computer program including instructions for determining a metric for evaluating a quality of a generative, multi-modal, foundation model, the instructions, when executed by at least one processor, causing the at least one processor to perform the following step comprising:
determining a first answer to a first question using the generative foundation model;
determining a second answer to a second question using the generative foundation model;
specifying a relation between the first answer and the second answer; and
determining the metric depending on the first and second answers and the relation.
